(19) United States
(12) Patent Application Publication
(10) Pub. No.: US 2011/0122225 A1
(43) Pub. Date: May 26, 2011

(54) Depth Coding as an Additional Channel to Video Sequence

(75) Inventors: Jae Hoon Kim, San Diego, CA (US); Limin Wang, San Diego, CA (US)

(73) Assignee: General Instrument Corporation, Horsham, PA (US)

(21) Appl. No.: 12/952,781

(22) Filed: Nov. 23, 2010

Related U.S. Application Data
(60) Provisional application No. 61/263,516, filed on Nov. 23, 2009.

(51) Int. Cl. H04N 13/00

(52) U.S. Cl. 348/42; 348/E13.062

(57) ABSTRACT

A 3D video coding apparatus and method which selectively codes video data from a plurality of video sources to include depth information. Coding may be performed by combining depth information with view information, such as RGB, YCrCb, or YUV, and coded together with the view information as, RGBD, YCrCbD or YUVD. An apparatus may selectively code the depth information based on a depth format flag to include no depth information (e.g. a 2D format) or include depth information as a chroma channel. The depth information may be coded separately or together with YCrCb based on a coding cost or rate distortion estimate to encode the video information to obtain the highest quality.

This application claims the benefit of U.S. Provisional Application 61/263,516 filed on Nov. 23, 2009, which is herein incorporated by reference in its entirety.

### FIELD OF INVENTION

The present invention relates to depth coding in a video image, such as in a 3D video image.

### BACKGROUND OF THE INVENTION

3D is becoming an attractive technology again, and this time it is gaining supports from content providers. Most of new animation movies and many films will be released also with 3D capability and can be watched in 3D movie theaters widespread across the country. Also there were several tests for real time broadcast of sports event, e.g., NBA and NFL games. To make 3D perceived in flat screens, stereopsis is used, which mimics human visual system and shows left and right views captured by stereo cameras to left and right eye, respectively. Therefore, it requires twice the bandwidth required for 2D sequences. 3D TV (3DTV) or 3D video (3DV) is the application which uses stereopsis to deliver 3D perception to viewers. However, because only two views for each eye are delivered in 3DTV, users can not change the view point which is fixed by contents provider.

Free viewpoint TV (FTV) is another 3D application which enables users to navigate through different view points and choose the one they want to watch. To make multiple viewpoints available, multi-view video sequences are transmitted to users. Actually, stereo sequences required for 3DTV can be regarded as a subset of multi-view video sequences if the distance between neighboring views satisfies the conditions for stereopsis. Because the amount of data increases linearly according to the number of views, multi-view video sequences need to be compressed efficiently for wide spread use.

As an effort to reduce bitrates of multi-view video sequences, JVT had been working on multi-view video coding (MVC) and finalized it as an amendment to H.264/AVC. In MVC, multi-view video sequences are encoded using both temporal and cross-view correlations for higher coding efficiency while increasing dependency between frames both in time and across views. Therefore, when users want to watch a specific view, unnecessary views should be decoded according to the dependency. Furthermore, compression efficiency of MVC is not satisfactory when there are geometric distortions by camera disparity and the correlation between neighboring views is small.

### SUMMARY OF THE INVENTION

In accordance with the principles of the invention, an apparatus of the invention may comprise an encoder configured to encode the video data by encoding a combined set of view data and depth data. The combined set of view data and depth data may include one of: RGBD, YUVD, or YCbCrD. The combined set of view data and depth data may be contained in at least one of: a group of pictures, a picture, a slice, a group of blocks, a macroblock, or a sub-macroblock. The apparatus may further comprise a depth format unit configured to identify a depth format of the video data. The encoder may select to encode the video data as a plurality of two dimensional images without including depth data when the depth format is set to 0, or the encoder may select to encode the video data as a combined set of view data and depth data when the depth format is set to a predetermined level. The encoder may further include a coding cost calculator which determines coding costs of joint encoding of said combined set of view data and depth data and separate encoding of said combined set of view data and depth data, and determines an encoding mode between joint encoding and separate encoding based on said coding cost. The encoder may encode the video data as a joint encoding of view data and depth data when the encoding cost is less than an encoding cost of separately encoding the view data and depth data. The video data may be one of a: multiview with depth, multiview without depth, single view with depth, single view without depth.

In accordance with the principles of the invention, a method of encoding video data may comprise encoding the video data by encoding a combined set of view data and depth data at an encoder. The combined set of view data and depth data may include one of: RGBD, YUVD, or YCbCrD. The combined set of view data and depth data is contained in at least one of: a group of pictures, a picture, a slice, a group of blocks, a macroblock, or a sub-macroblock. The method may further comprise identifying a depth format of the video data. The video data may be encoded as a plurality of two dimensional images without including depth data when the depth format is set to 0. The video data may be encoded as a combined set of view data and depth data when the depth format is set to a predetermined level. The method may further include determining a coding cost of joint encoding said combined set of view data and depth data and separate encoding of said combined set of view data and depth data, and determining an encoding mode between joint encoding and separate encoding based on said coding cost. The video data may be encoded as a joint encoding of view data and depth data when the encoding cost is less than an encoding cost of separately encoding the view data and depth data. The video data may be one of a: multiview with depth, multiview without depth, single view with depth, single view without depth.

In accordance with the principles of the invention, a non-transitory computer readable medium carrying instructions for an encoder to encode video data, may comprise instructions to perform the step of: encoding the video data by encoding a combined set of view data and depth data. The combined set of view data and depth data may include one of: RGBD, YUVD, or YCbCrD. The combined set of view data and depth data is contained in at least one of: a group of pictures, a picture, a slice, a group of blocks, a macroblock, or a sub-macroblock. The instructions may further comprise identifying a depth format of the video data. The video data may be encoded as a plurality of two dimensional images without including depth data when the depth format is set to 0. The video data may be encoded as a combined set of view data and depth data when the depth format is set to a predetermined level. The instructions may further include determining a coding cost of joint encoding said combined set of view data and depth data and separate encoding of said combined set of view data and depth data, and determining an encoding mode between joint encoding and separate encoding based on said coding cost. The video data may be encoded as a joint encoding of view data and depth data when the encoding cost is less than an encoding cost of separately encoding the view data and depth data. The video data may be one of a: multiview with depth, multiview without depth, single view with depth, single view without depth.

In accordance with the principles of the invention, an apparatus for decoding video data may comprise: a decoder configured to decode the video data by decoding a combined set of view data and depth data. The combined set of view data and depth data may include one of: RGBD, YUVD, or YCbCrD. The combined set of view data and depth data may be contained in at least one of: a group of pictures, a picture, a slice, a group of blocks, a macroblock, or a sub-macroblock. The apparatus may further comprise a depth format unit configured to identify a depth format of the video data. The decoder may select to decode the video data as a plurality of two dimensional images without including depth data when the depth format is set to 0. The decoder may select to decode the video data as a combined set of view data and depth data when the depth format is set to a predetermined level. The decoder may selectively jointly decodes said combined set of view data and depth data when said combined set was jointly encoded or decodes said combined set of view data and depth data when said combined set was separately encoded. The video data may be one of a: multiview with depth, multiview without depth, single view with depth, single view without depth.

In accordance with the principles of the invention, a method decoding video data comprising: decoding the video data by decoding a combined set of view data and depth data at a decoder. The combined set of view data and depth data may include one of: RGBD, YUVD, or YCbCrD. The combined set of view data and depth data is contained in at least one of: a group of pictures, a picture, a slice, a group of blocks, a macroblock, or a sub-macroblock. The method may further comprise identifying a depth format of the video data. The video data may be decoded as a plurality of two dimensional images without including depth data when the depth format is set to 0. The video data may be decoded as a combined set of view data and depth data when the depth format is set to a predetermined level. The method may further include selectively jointly decoding said combined set of view data and depth data when said combined set was jointly encoded or decoding said combined set of view data and depth data when said combined set was separately encoded. The video data may be one of a: multiview with depth, multiview without depth, single view with depth, single view without depth.

In accordance with the principles of the invention, a non-transitory computer readable medium may carrying instructions for an decoder to decode video data, comprising instruction to perform the steps of: decoding the video data by encoding a combined set of view data and depth data. The combined set of view data and depth data may include one of: RGBD, YUVD, or YCbCrD. The combined set of view data and depth data is contained in at least one of: a group of pictures, a picture, a slice, a group of blocks, a macroblock, or a sub-macroblock. The instructions may further comprise identifying a depth format of the video data. The video data may be decoded as a plurality of two dimensional images without including depth data when the depth format is set to 0. The video data may be decoded as a combined set of view data and depth data when the depth format is set to a predetermined level. The instructions may further include selectively jointly decoding said combined set of view data and depth data when said combined set was jointly encoded or decoding said combined set of view data and depth data when said combined set was separately encoded. The video data may be one of a: multiview with depth, multiview without depth, single view with depth, single view without depth.

The invention allows 3D encoding of a depth parameter jointly with view information. The invention allows for compatibility with 2D and may provide optimized encoding based on the RD costs in encoding depth jointly with view or separately. Also, from the new definition of video format, we provide an adaptive coding method of 3D video signal. During the combined coding of YCbCrD in the adaptive coding of 3D signal, we treat depth as a video component from the beginning thus, in inter prediction, block mode and reference index are shared between view and depth in addition to motion vector. In intra prediction, intra prediction mode can be shared also. Note that the coding result of combined coding can be further optimized by considering depth information together with view. In the separate coding of view and depth, depth is coded independently to the view. It is also possible to have intra coded depth while view is inter coded.

### BRIEF DESCRIPTION OF THE DRAWINGS

FIG. 1 illustrates an end-to-end 3D/FTV system.

FIG. 2 illustrates an approach for depth estimation.

FIGS. 3A-3D illustrate a sample video image in various forms.

FIG. 4 illustrates an encoder and decoder arrangement in accordance with the principles of the invention.

FIG. 5 illustrates a flowchart of RD optimization (RDO) in each macroblock between combined coding and separate coding in accordance with the principles of the invention.

FIG. 6 illustrates a flowchart for adaptive coding of 3D video in accordance with the principles of the invention.

FIGS. 7A-7D illustrate a sample image and a chart of PSNR of view and depth.

FIGS. 8A and 8B illustrate the depth of Lovebird 1, View 2 in time 0 and time 1.

FIG. 9A and 9B show RD curves of synthesized views for Lovebird1 and Pantomime.

FIGS. 10A and 10B illustrate luma and depth of Lovebirds from FIG. 3.

FIGS. 11A and B illustrate other sample images, including Lovebird 2 and Pantomine.

### DETAILED DESCRIPTION

For simplicity and illustrative purposes, the present invention is described by referring mainly to exemplary embodiments thereof. In the following description, numerous specific details are set forth to provide a thorough understanding of the present invention. However, it will be apparent to one of ordinary skill in the art that the present invention may be practiced without limitation to these specific details. In other instances, well known methods and structures have not been described in detail to avoid unnecessarily obscuring the present invention.

FIG. 1 shows an exemplary diagram for end-to-end 3D/FTV system. As shown in FIG. 1, multiple views are captured of a scene or object 1 by multiple cameras 2. The captured views by the multiple cameras 2 are corrected or rectified and sent to a processor and storage system 7 prior to transmission by a transmitter 3. The processor may include an encoder which encodes the image data into a specified format. At the encoder, multiple views are available which can be used to estimate depth more efficiently and correctly.

As illustrated in FIG. 1, a user's side generally includes a receiver 6 which receives the transmitted and encoded images from transmitter 3. The received data is proved to a processor/buffer which typically includes a decoder. The decoded and otherwise processed image data is provided to display 5 for viewing by the user.

MPEG started to search for a new standard for multi-view video sequence coding. In MPEG activity, depth information is exploited to improve overall coding efficiency. Instead of sending all multi-view video sequences, sub-sampled views, 2 or 3 key views are sent with corresponding depth information and intermediate views are synthesized using key views and depths. Depth is assumed to be estimated (if not captured) before compression at the encoder and intermediate views are synthesized after decompression at the decoder. Note that not all captured views are compressed and transmitted in this scheme.

To define suitable reference techniques, four exploration experiments (EE1-EE4) have been established in MPEG. EE1 explores depth estimation from neighboring views and EE2 explores view synthesis techniques which synthesize intermediate views using estimated depth from EE1. EE3 searched techniques for generation of intermediate views based on layered depth video (LDV) representation. EE4 explores how the depth map coding affects the quality of synthesized views.

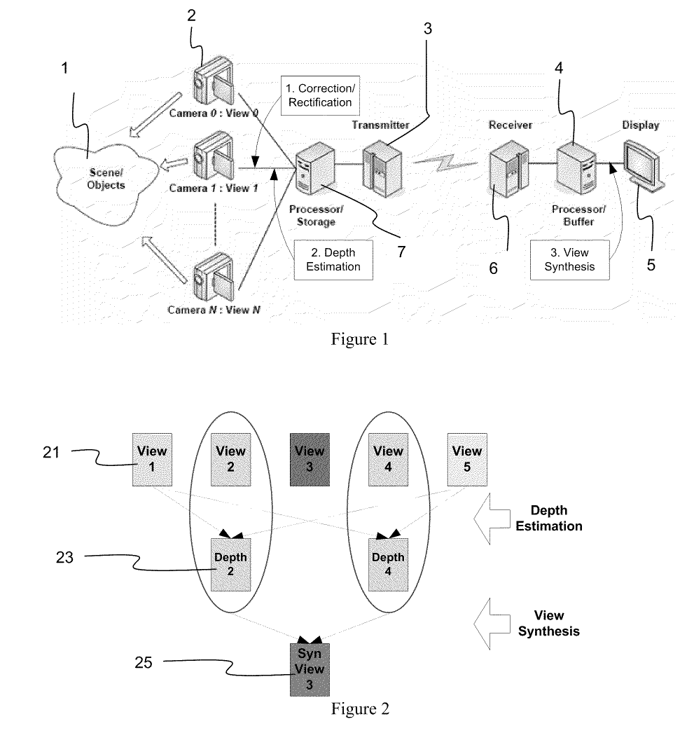

In FIG. 2, EE1 for depth estimation and EE2 for view synthesis are described. For multi-view sequences, e.g., from View 1 to 5, shown in row 21 in FIG. 2, any two views can be selected to estimate depth between them. For example, View 1 and View 5 are used to estimate Depth 2 and Depth 4, shown in row 23. Then View 2, Depth 2, View 4 and Depth 4 can be encoded and transmitted to the users and intermediate views between View 2 and View 4 can be synthesized using Depth 2 and Depth 4 with corresponding camera parameters. In FIG. 2, View 3 is synthesized, shown in row 25, and compared with original View 3.

In O. Stankiewicz, K. Wegner and K. Klimaszewski, “Results of 3DV/FTV Exploration Experiments, described in w10173,” ISO/IEC JTC1/SC29/WG11 MPEG Document M16026, Lausanne, Switzerland, February 2009, it was observed that the quality of synthesized view depends more on the quality of encoded view than on the quality of encoded depth. In S. Tao, Y. Chen, M. Hannuksela and H. Li, “Depth Map Coding Quality Analysis for View Synthesis,” ISO/IEC JTC1/SC29/WG11 MPEG Document M16050, Lausanne, Switzerland, February 2009, view is synthesized depending on depth that is encoded in different bit rates. They provided rate and distortion (R-D) curves where rate is shown in Kbps for depth coding and distortion is shown in PSNR for synthesized view. As can be seen in Tao, et al., the quality of synthesized view does not change significantly in most range of bit rates for depth. In C. Cheng, Y. Huo and Y. Liu, “3DV EE4 results on Dog sequence,” ISO/IEC JTC1/SC29/WG11 MPEG Document M16047, Lausanne, Switzerland, February 2009, multi-view video coding (MVC) is used to encode stereo views and depths and compared with coding results when H.264/AVC is used to encode each view independently. MVC showed less than 5% coding gains compared to simulcast by H.264/AVC. For depth compression, in B. Zhu, G. Jiang, M. Yu, P. An and Z. Zhang, “Depth Map Compression for View Synthesis in FTV,” ISO/IEC JTC1/SC29/WG11 MPEG Document M16021, Lausanne, Switzerland, February 2009, depth is segmented and different regions are defined as edge (A), motion (B), inner part of moving object (C) and background (D). Depending on the region type, different block modes are applied, which resulted in less encoding complexity and improved coding efficiency in depth compression.

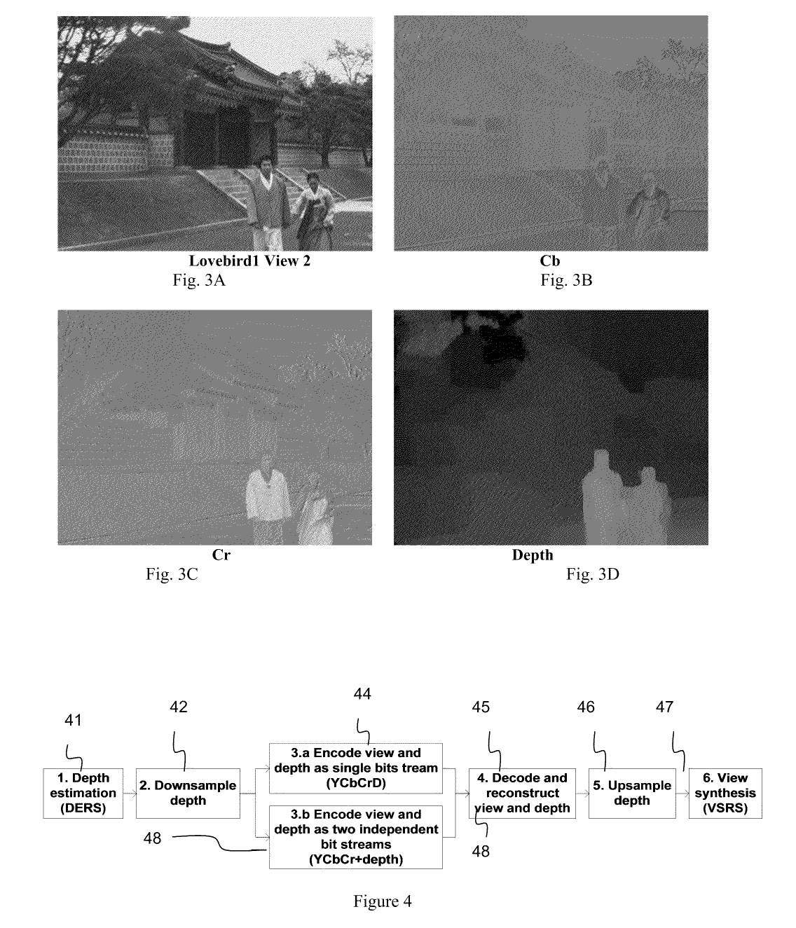

During the 2D video capture, scenes or objects in 3D space are projected into image plane of the camera, where the pixel intensity represents the texture of the objects. In depth map, pixel intensity represents the distance of the corresponding 3D objects to/from the image plane. Therefore, both view and depth are captured (or estimated for depth) for the same scene or objects thus, they share the edges or the contours of the objects. FIG. 3a shows the original view 0, FIG. 3b-3d show the corresponding Cb, Cr and depth of the sequence, Lovebirds, from ETRI/MPEG Korea Forum “Call for Proposals on Multi-view Video Coding,” ISO/IEC JTC1/SC29/WG11 MPEG Document N7327, Poznan, Poland, July 2005, herein incorporated by reference. FIGS. 11A and 11B show other views, including Lovebird 2 View 7 and Pantomime View 37. With reference to FIG. 3b-3d, from the comparison of Cb/Cr with depth, it can be seen that both Cb/Cr and depth share object boundary. For example, an image is segmented based on color for the disparity (depth) estimation because color channel shares the information of object boundaries G. Um, T. Kim, N. Hur, and J. Kim, “Segment-based Disparity Estimation using Foreground Separation,” ISO/IEC JTC1/SC29/WG11 MPEG Document M15191, Antalya, Turkey, January 2008.

According to O. Stankiewicz et al., Tao et al., Cheng, et al. and Zhu et al., it can be derived that the quality of depth does not change the quality of synthesized view significantly. However, all the results in these contributions are obtained using MPEG reference software for depth estimation and view synthesis which are often not the state-of-the-art technology. Estimated depths are often different even for the same smooth objects and temporal inconsistencies are easily observed. Therefore, it can not be concluded that the quality of the synthesized view does not depend on the quality of the depth. Furthermore, 8 bit depth quality currently assumed in MPEG activity may not be enough considering that 1 pixel error around object boundary in view synthesis may results in different synthesis results.

However with all these uncertainties, depth should be encoded and transmitted with view for 3D services and an efficient and flexible coding scheme needs to be defined. Noting that the correlation between view and depth can be exploited, just as the correlation between luma and chroma is exploited during the transition from monochrome to color, we provide a new flexible depth format and coding scheme which is backward compatible and suitable for different objectives of new 3D services. The determination of the depth data may be performed by the techniques discussed above or another suitable approach.

We treat depth as an additional component to conventional 2D video format, making a new 3D video format. Thus, for example, RGB or YCbCr format is expanded to RGBD or YCbCrD to include depth. In H.264/AVC, the format for monochrome or color can be selected by chroma_format_idc flag. Similarly we may use a depth_format_idc flag to specify if a signal is 2D or 3D. Table 1 shows how to use chroma_format_idc and depth_format_idc to signal video format in 2D/3D and monochrome/color.

TABLE 1
Different video format defined by depth_{—}
format_idc and chroma_format_idc

| Video format | | depth_format_idc | chroma_format_idc |
|---|---|---|---|
| 2D | Monochrome | 0 | 0 |
| | Color | 0 | >0 |
| 3D | Monochrome | >0 | 0 |
| | Color | >0 | >0 |

In the extended video format definition, there would be the better grouping of channels for compression e.g., depending on the resolution of each channel or correlations among them. Table 2 exemplifies how video components can be grouped to exploit the correlation among them. Index 0 means YCbCrD are all grouped together and encoded by the same block mode. This is the case that the same motion vector (MV) or the same intra prediction direction is used for all channels. For index 1, depth is encoded separately to view. Index 5 specifies each channel is encoded independently.

TABLE 2
Grouping of Components for Compression.

| Group index | Y (R) | Cb (G) | Cr (B) | D |
|---|---|---|---|---|
| 0 | 0 | 0 | 0 | 0 |
| 1 | 0 | 0 | 0 | 1 |
| 2 | 0 | 1 | 1 | 1 |
| 3 | 0 | 1 | 1 | 0 |
| 4 | 0 | 1 | 1 | 2 |
| 5 | 0 | 1 | 2 | 3 |

The same number means they are grouped together for encoding/decoding.

Depending on the correlations between each channel, channels can be grouped differently. For example, assume that YUV420 is used for the view and depth is quite smooth, thus the same resolution to chroma is enough for depth signal. Then, Cb, Cr and D can be treated as a group and Y as another group. Then group index 2 can be used assuming Cb, Cr and D can be similarly encoded without affecting overall compression efficiency. If the resolution of depth is equal to that of luminance in YUV420 format and depth needs to be coded in high quality, group index 1 or group index 4 can be used. If there is enough correlation between Y and D, group index 3 can be used additionally. In the next, we assume two different applications for 3D and show how we can exploit the correlation between view and depth under the new video signal format. Note that the approaches explained next can be similarly applied to different combination of groups.

First, we assume that estimated depth quality is not accurate enough or is not required to be accurate thus, basic depth information e.g., the object boundaries and approximate depth values would be satisfactory for required view synthesis quality. Depth estimation or 3D services in mobile devices can be an example of this case, where the highest priority would be a less complex depth coding. Second, for 3D services in HD quality, high quality depth information would be required and coding efficiency would be the highest priority.

In one implementation using H.264/AVC for 2D view compression, depth_format_idc may be defined in Table 3 to specify additional picture format YCbCrD. If sequence does not have depth for 3D application, it is set to 0 and sequence is encoded by standard H.264/AVC. If sequence carries depth channel, depth can be encoded in the same size to luma (Y) when depth format is ‘D4’ or encoded in the same size to chroma (Cb/Cr) when depth format is ‘D1’ where the width and height of D1 can be half of D4 or equal to D4 depending on SubWidthC and SubHeightC, respectively. The associated syntax change in sequence parameter set of H.264/AVC is shown in Table 4. Those of skill in the art will appreciate that the encoder preferably sets the various syntax values in Table 4 during an encoding process, and the decoder may use the values during the decoding process.

TABLE 3
SubWidthD and SubHeightD derived from depth_format_idc

| depth_format_idc | Depth Format | SubWidthD | SubHeightD |
|---|---|---|---|
| 0 | No depth (2D) | — | — |
| 1 | D1 | SubWidthC | SubHeightC |
| 2 | D4 | 1 | 1 |

TABLE 4
Sequence parameter set RBSP syntax.

| seq_parameter_set_rbsp( ) { | | C | Descriptor |
|---|---|---|---|
| | profile_idc | 0 | u(8) |
| | constraint_set0_flag | 0 | u(1) |
| | constraint_set1_flag | 0 | u(1) |
| | constraint_set2_flag | 0 | u(1) |
| | constraint_set3_flag | 0 | u(1) |
| | reserved_zero_4bits /* equal to 0 */ | 0 | u(4) |
| | level_idc | 0 | u(8) |
| | seq_parameter_set_id | 0 | ue(v) |
| | if( profile_idc = = 100 \|\| profile_idc = = 110 \|\| | | |

| | | |
|---|---|---|
| profile_idc = = 122 \|\| profile_idc = = 144 ) { | | |
| chroma_format_idc | 0 | ue(v) |
| depth_format_idc | 0 | ue(v) |
| if( chroma_format_idc = = 3 ) | | |

| | | |
|---|---|---|
| residual_colour_transform_flag | 0 | u(1) |

| | | |
|---|---|---|
| bit_depth_luma_minus8 | 0 | ue(v) |
| bit_depth_chroma_minus8 | 0 | ue(v) |
| if( depth_format_idc > 0) | | |

| | | |
|---|---|---|
| bit_depth_depth_minus8 | 0 | ue(v) |

| | | |
|---|---|---|
| qpprime_y_zero_transform_bypass_flag | 0 | u(1) |

[symbol]

if( vui_parameters_present_flag )

| | |
|---|---|
| vui_parameters( ) | 0 |

| | |
|---|---|
| rbsp_trailing_bits( ) | 0 |

}
Added syntaxes are ‘depth_format_idc’.

Assuming depth values may be mapped by a 8 bit signal, to specify the bit depth of the samples of the depth array and the value of the depth quantization parameter range offset QpBdOffset_{D}, bit_depth_depth_minus8 is added in the sequence parameter set as shown in Table 4. BitDepth_{D} and QpBdOffset_{D} are specified as;

BitDepth_{D}=8+bit_depth_depth_minus8 (1)

QpBdOffset_{D}=6*bit_depth_depth_minus8 (2)

Note that if the depth values are decided to be represented by N bits basically, the equation can be changed accordingly, for example, BitDepth_{D}=N+bit_depth_depth_minusN.

To control the quality of encoded depth independent to YCbCr coding, depth_qp_offset is present in picture parameter set syntax when depth_format_idc>0. In Table 5, associated syntax change in H.264/AVC is shown. The value of QP_{D} for depth component is determined as follows;

The variable qD_{offset} for depth component is derived as follows.

qD_{offset}=depth_{—}qp_offset (3)

The value of QP_{D} for depth component is derived as

QP_{D}=Clip3(−QpBdOffset_{D}, 51, QP_{Y}+qD_{Offset}) (4)

The value of QP′_{D} for the depth components is derived as

QP′_{D}=QP_{D}+QpBdOffset_{D} (5)

TABLE 5
Picture parameter set RBSP syntax.

| pic_parameter_set_rbsp( ) { | | C | Descriptor |
|---|---|---|---|
| | pic_parameter_set_id | 1 | ue(v) |
| | seq_parameter_set_id | 1 | ue(v) |
| | entropy_coding_mode_flag | 1 | u(1) |
| | pic_order_present_flag | 1 | u(1) |
| | num_slice_groups_minus1 | 1 | ue(v) |
| | if( num_slice_groups_minus1 > 0 ) { | | |

[symbol]

| | | |
|---|---|---|
| } | | |
| num_ref_idx_10_active_minus1 | 1 | ue(v) |
| num_ref_idx_11_active_minus1 | 1 | ue(v) |
| weighted_pred_flag | 1 | u(1) |
| weighted_bipred_idc | 1 | u(2) |
| pic_init_qp_minus26 /* relative to 26 */ | 1 | se(v) |
| pic_init_qs_minus26 /* relative to 26 */ | 1 | se(v) |
| chroma_qp_index_offset | 1 | se(v) |
| if (depth_format_idc > 0) | | |

| | | |
|---|---|---|
| depth_qp_offset | 1 | se(v) |

[symbol]

}
Modified syntax is ‘depth_qp_offset’.

The block coding may include using macroblocks or multiples of macroblocks, e.g. MB pairs. A YCrCbD MB may consist of Y 16×16, Cr 8×8, Cb 8×8 and D 8×8, for example. However, various block sizes may be used for each of Y, Cr, Cb and D. For example, D may have a size of 8×8 or 16×16.

Next, YCbCrD coding schemes for depth format D1 and D4 are explained. In one implementation for depth format D1, we encode depth map in a similar way that chroma is coded in H.264/AVC exploiting the correlation between Cb/Cr and D. For the implementation of depth coding, such as in H.264/AVC, depth is treated as if were a third chroma channel, Cb/Cr/D. Therefore, the same block mode, intra prediction direction, motion vector (MV) and reference index (refIdx) are applied to Cb/Cr and D. Also coded block pattern (CBP) in H.264/AVC is redefined in Table 6 to include CBP of depth. For example, when deciding intra prediction direction for chroma, depth cost is added to calculate total cost for Cb/Cr/D and depth shares the same intra prediction direction with Cb/Cr. In block mode decision at the encoder, rate-distortion (RD) cost of depth is added to total RD cost for YCbCr, thus mode decision is optimized for both view and depth. The only information not shared with Cb/Cr is the residual of depth, which is encoded after residual coding of Cb/Cr depending on CBP.

TABLE 6
Specification of modified CodedBlockPatternChroma values

| CodedBlockPatternChroma | Description |
|---|---|
| 0 | All chroma/depth transform coefficient |
| | levels are equal to 0. |
| 1 | One or more chroma/depth DC transform |
| | coefficient levels shall be non-zero |
| | valued. All chroma/depth AC transform |
| | coefficient levels are equal to 0. |
| 2 | Zero or more chroma/depth DC transform |
| | coefficient levels are non-zero |
| | valued. One or more chroma/depth AC |
| | transform coefficient levels shall be |
| | non-zero valued. |

When the computational power for depth estimation is limited, e.g., in mobile devices or real time depth estimation is required, it might be difficult to estimate a full resolution depth map equal to the original frame size or the estimated depth might not be accurate with incorrect information or noisy depth values around object boundaries. When estimated depth is not accurate, it might not be necessary to encode noisy depth in high bit rates. In I. Radulovic and P. Fröjdh, “3DTV Exploration Experiments on Pantomime sequence,” ISO/IEC JTC1/SC29/WG11 MPEG Document M15859, Busan, Korea, October 2008, it is shown that as the smoothing coefficient in depth estimation reference software (DERS) increases, less detailed and less noisy depth maps were obtained resulting in better qualities of synthesized views. In this case, our objective would be the simplicity of depth coding. We encode depth map in a similar way that chroma is coded in H.264/AVC exploiting the correlation between Cb/Cr and D. Next, we show how coding information can be shared between Cb/Cr and depth in the implementation in H.264/AVC.

FIG. 4 illustrates an apparatus for estimating or simulating depth coding in accordance with the invention. For given sequences, we use a DERS 41 module for depth estimation and then downsample the depth map by 2 both horizontally and vertically using a down sampling module 42, such as a polynorm filter David Baylon, “Polynorm Filters for Image Resizing: Additional Considerations,” Motorola, Home & Networks Mobility, Advanced Technology internal memo DSM2008-072r1, December 2008. The downsampled depth map has the same resolution as the chroma channels in YUV 4:2:0 format. As a baseline, view and depth are coded separately by encoders 48, which may be two H.264/AVC encoders, thus 2 independent bit streams are generated. While two encoders are illustrated for the baseline encoding, those of skill in the art will appreciate that the same (a single) encoder may be used for the baseline encoding processes. As a D1 encoding scheme, view and depth are coded jointly by encoder 44 to create a single bit stream.

The encoded image may be provided to a downstream transmitter 3 (see, FIG. 1) and transmitted to a remotely located decoder 45, as generally shown by the direction arrow in FIG. 4. Those of skill in the art will appreciate that the encoder may be in a network element, e.g. a headend unit, the decoder may be in a user device, e.g. a set top box. The decoder decodes and reconstructs the view and depth parameters. Reconstructed depths are upsampled to the original size using and up sampler 46, such as a polynorm filter again in Baylon's approach, and fed into a view synthesis module 47, which may include view synthesis reference software (VSRS) with reconstructed views to synthesize additional views. Because combined YCbCrD coding generates single bit stream for both view and depth, bit rates of 2 bit streams in separate codings (YCbCr+D) are summed and compared with bit rates of YCbCrD coding.

The encoding may be performed with Y and RD optimization. In one implementation for depth format D4, we target coding efficiency of overall YCbCrD sequences exploiting the correlation between view and depth. Because depth resolution is equal to luma, Y, instead of Cb/Cr, coding information of Y is shared for efficient depth coding. FIGS. 10A and 10B show luma and depth of Lovebirds from FIG. 3. Although the similarity in object shapes and boundaries can be observed, it is still possible that the best match minimizing distortion can be found in the different locations for Y and D, respectively. For example, in FIG. 10A and 10B, the best match of the grass in Y might not be the best match in D because the texture of the grass repeats in Y while depth of grass looks noisy. Therefore, instead of sharing coding information over the whole picture, we may select whether to share coding information of Y with depth or not in coding each macroblock depending on the RD cost between combined coding (share) and separate coding (not share) of view and depth.

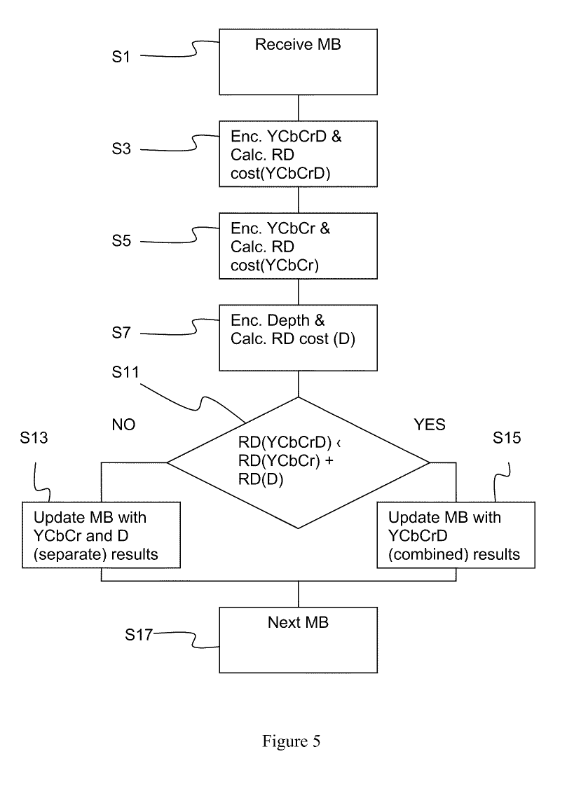

FIG. 5 illustrates a flowchart of rate distortion optimization (RDO) in each macroblock between combined coding and separate coding. A macroblock (MB) is received in step S1. View and depth is encoded as a combined YCbCrD and calculated RD cost in step S3, RDcost(YCbCrD). The best coding information found is saved, including intra prediction mode, motion vector and reference index, such as for both the joint coding of view and depth and the independent coding of view and depth. The view and depth are encoded independently and the individual RD cost, RDcost(YCbCr) and RDcost(D) are calculated, steps S5 and S7. We compare RDcost(YCbCrD) and ‘RDcost(YCbCr)+RDcost(D)’, step S11. The one with the minimum RD cost for the current macroblock is selected. That is, if the RD cost of the combined YCbCrD is less than the RD cost of the separate RD(YCbCr)+RD(D), the MB is updated with the combined results (YCbCrD), step S15. If the RD cost of the combined YCbCrD is not less than the RD cost of the separate RD(YCbCr)+RD(D), the MB is updated with the separate results (YCbCr and D), step S13. The next MB is taken to be processed in step S17. Two separate coded block information for YCbCr and D may be maintained, respectively, as a reference to encode future macroblocks.

When combined YCbCrD coding is applied, the similarities of the edges and the contours of objects in Y and D are exploited by sharing block mode, intra prediction direction, MV and refIdx. However the textures of Y and D are not similar in general therefore, coded block pattern (CBP) and residual information are not shared in the combined coding. Table 7 summarizes shared and non-shared information in YCbCrD combined coding.

TABLE 7
Shared and non-shared information in YCbCrD combined coding

| | | Non-shared |
|---|---|---|
| | Shared information | information |
| INTRA | Block mode, intra | CBP, Residual |
| | prediction | |
| | direction | |
| INTER | Block mode, | CBP, Residual |
| (16 × 16, . . . , 8 × 8) | MV, RefIdx | |

To signal whether combined coding or separate coding is used in each macroblock, mb_YCbCrD_flag is introduced as a new flag which can be 0 or 1 indicating separate or combined coding, respectively. This flag may be encoded by CABAC and three contexts are defined by mb_YCbCrD_flag from the neighboring left and upper blocks. The context index c for current MB is defined as follows;

c=mb_YCbCrD_flag (in the left MB)+mb_YCbCrD_flag (in the upper MB)

Under this approach, we provide a new video format which is compatible with conventional 2D video thus can be used for both 2D and 3D video signal. If 3D video signal, e.g., YCbCrD, is sent, depth is included as a video component. If only 2D video signal, e.g., YCbCr, is sent without depth, 2D video can be sent with depth_format_idc equal to 0 specifying there is no depth component.

Also, from the new definition of video format, we provide an adaptive coding method of 3D video signal. During the joint coding of YCbCrD in the adaptive coding of 3D signal, we treat depth as a video component from the beginning thus, in inter prediction, block mode and reference index are shared between view and depth in addition to motion vector (MV). In intra prediction, intra prediction mode can be shared also. Note that the coding result of combined coding can be further optimized by considering depth information together with view. In the separate coding of view and depth, depth is coded independently to the view. For example, depth can be encoded/decoded by 16×16 inter block mode while view is coded as 8×8 inter block mode. It is also possible to have intra coded depth while view is inter coded. Note that RD optimized adaptive coding is possible by treating depth as an additional channel to view, not by re-using MV from view to depth.

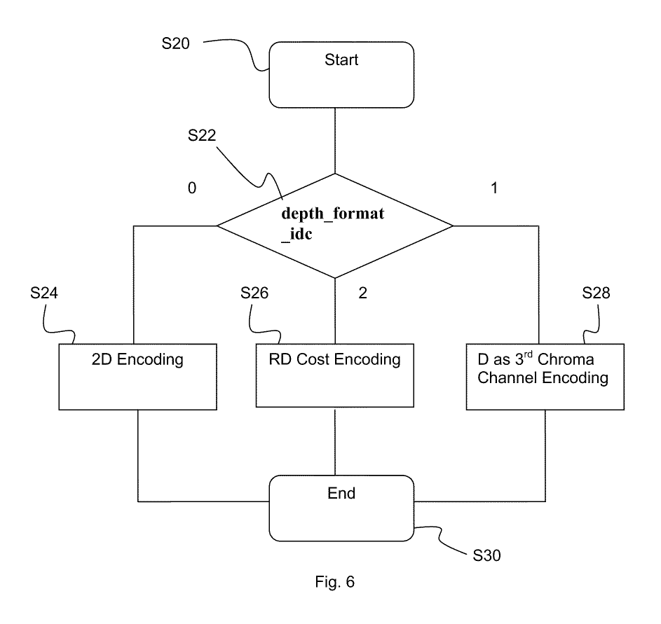

Combining foregoing, FIG. 6 shows a flowchart for adaptive coding of 3D video in accordance with the invention. The processes starts at step S20. As shown in step S22, with the depth_format_idc flag equal to 0, video signal is treated as 2D and conventional 2D encoding (e.g. H.264/AVC, MPEG 2, or H.265/HEVC) is used, step S24. If the depth_format_idc flag is 1, depth is encoded as if it is a third chroma channel, which is the same resolution as for the chroma, step S28. With the depth_format_idc flag equal to 2, depth is the same resolution as the luma and adaptive joint/separate coding is applied to view and depth based on RD cost (steps S26). As shown in FIG. 6, the RD cost may be determined according to the process shown in FIG. 5. Note that we showed how the adaptive coding can be applied between group index 0, 1, 3 and 4 in Table 2. This approach can be extended to any group index in Table 2 according to the application, correlation between channels, etc.

For the D1 approach discussed above, which provides simplicity in depth coding, based on the observation of the correlation between view and depth, we extend the current YCbCr sequence format into YCbCrD so that depth can be treated and encoded as an additional channel to view. From this extended format, we showed two different compression schemes of YCbCrD. With depth format D1, depth is encoded in H.264/AVC, sharing coding information with Cb/Cr, therefore additional encoder complexity is negligible and overall encoder complexity is similar to the original H.264/AVC. In depth format D4, depth can be encoded sharing coding information with Y. Noting that the best predictions for Y and D can be different even for the same object, combined coding or separate coding of YCbCr and D is decided by RD cost of each approach.

In the experimental results with depth format D1 and D4, it was verified that our encoding method for depth achieves the goals, less complex encoder for depth format D1 and higher coding efficiency for depth format D4.

The YCbCrD coding in depth format D1 was implemented in a Motorola H.264/AVC encoder (Zeus) and compared with independent coding of YCbCr and depth. We used View 1, 2, 3, 4 and 5 from Lovebird1, and other images, e.g. View 36, 37, 38, 39 and 40 from Pantomime following MPEG EE1 and EE2 procedure shown in FIG. 2. View 3 in Lovebird1 is synthesized and the qualities of synthesized views are compared with the original views. Original Lovebird1 sequence is YUV 4:2:0 format and depth_format_idc is set to 1, thus depth array has the same size as Cb and Cr.

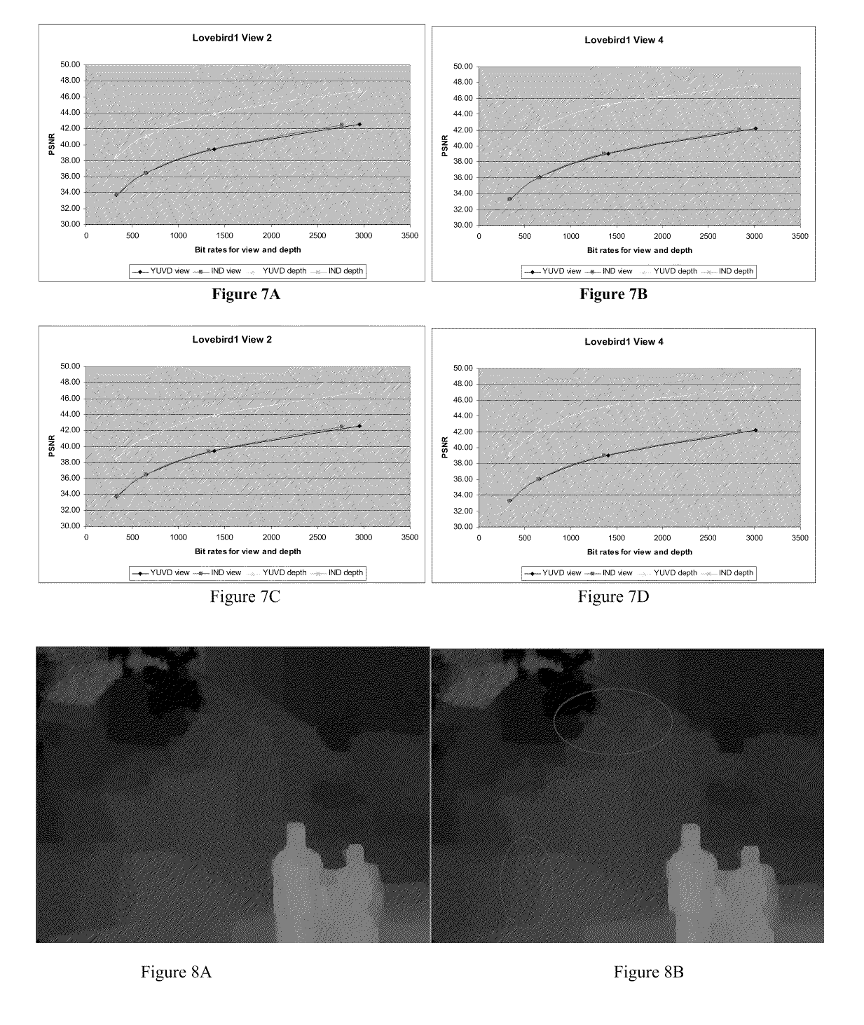

In FIGS. 7A-7D the Peak Signal to Noise Ratio (PSNR) of view and depth are shown with respect to total bit rate for Lovebird1 and Pantomime, respectively. Images for Lovebird 2 and Pantomime may be found in FIGS. 11A and 11B, respectively. More specifically, FIG. 7A and 7B illustrates a chart of PSNR vs total bit rate for the image Loverbird 1, and FIGS. 7C and 7D illustrates a chart for Pantomime. The charts illustrate that the quality of reconstructed depth by YCbCrD coding, shown by YUVD depth and triangles, is worse than that by independent depth coding, shown by IND depth and “x”s. However, the quality of reconstructed view by YCbCrD coding, shown by YUVD view and diamonds, is similar to that by independent coding, shown by IND view and squares. This is because the estimated depth map is not consistent in time, as can be seen in FIGS. 8a and 8b. Also, in YCbCrD coding, the encoder is not fully optimized to handle the temporal inconsistency for depth which is regarded as only an additional channel in YCbCrD sequence.

FIGS. 8A-8B illustrate the depth of Lovebird 1, View 2 in time 0 and time 1. Also note that in FIG. 8B, object boundaries in the estimated depth map are noisy and not aligned with object boundaries in view. Note in FIG. 8, that red circled areas belong to static background in view but have different intensities in depth. Besides red circled area, temporal inconsistencies can be found easily.

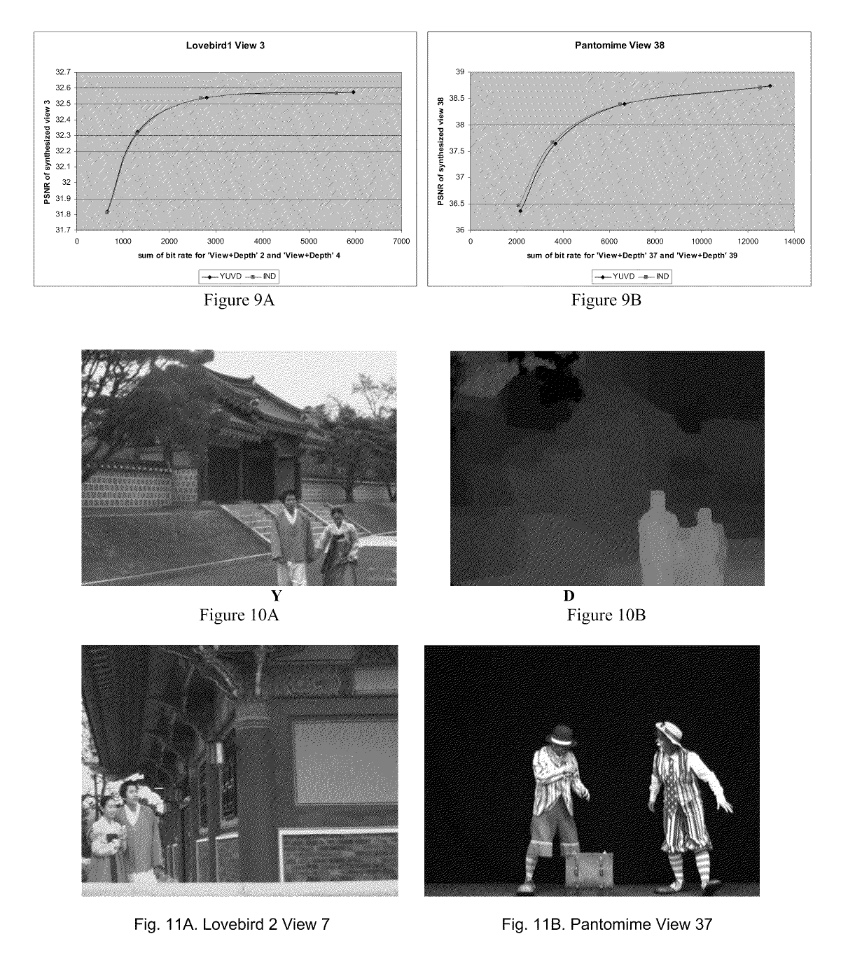

FIGS. 9A and 9B shows RD curves of synthesized views for Lovebird1 and Pantomime. Because intermediate view is synthesized by two neighboring views, bit rates for two neighboring views are added and used in the plot. For distortion, PSNR of synthesized view is used. The quality of synthesized view by YCbCrD coding is similar to that of independent coding in RD sense. In FIGS. 7A-7D, it has been shown that the decoded left and right views have similar quality in RD. Thus, the combined coding and separate coding have similar results in RD sense for key views and synthesized view. Note that depth maps are used to synthesize views and are not displayed for viewing. However, the combined YCbCrD coding provides a level of ease in implementation and provides for backward compatibility to existing coding standards in single bit stream. YCbCrD coding can be used as an extended format for depth coding and implemented easily in the conventional video coding standards.

For the D4 approach discussed above, which provides encoding efficiency, three sequences, provided by MPEG, Lovebird1, Lovebird2 and Pantomime were tested, which are MPEG sequences and depths are estimated by DERS. As a baseline, H.264/AVC is used to code view and depth separately and bit rates are added to get total bit rate for view and depth. Table 8 shows how many bits are required for independent coding of view and depth, respectively. The ratio of bits for depth and view ranges from 4.5% to 98%. Estimated depths for Lovebird1 and Lovebird2 are noisier than Pantomime and views are relatively static in time (not fast motion). Therefore, relatively more bits are needed for depth coding and less bits needed for view coding.

TABLE 8
Ratio of bits required to encode depth and view (IPPP by Zeus)

| | | QP 22 | QP 27 | QP 32 | QP 37 | Average |
|---|---|---|---|---|---|---|
| Lovebird1 | Bit (depth, Kbps) | 1159 | 536 | 236 | 106 | 509.25 |
| View 2 | Bit (view, Kbps) | 2356 | 1141 | 561 | 297 | 1088.75 |
| | Bit(depth)/Bit(view) | 49.19% | 46.98% | 42.07% | 35.69% | 46.77% |
| Lovebird2 | Bit (depth) | 925 | 490 | 247 | 126 | 447 |
| View 7 | Bit (view) | 958 | 487 | 245 | 131 | 455.25 |
| | Bit(depth)/Bit(view) | 96.56% | 100.62% | 100.82% | 96.18% | 98.19% |
| Pantomime | Bit (depth) | 273 | 142 | 80 | 51 | 136.5 |
| View 37 | Bit (view) | 6248 | 3223 | 1768 | 1029 | 3067 |
| | Bit(depth)/Bit(view) | 4.37% | 4.41% | 4.52% | 4.96% | 4.45% |

In Table 9, the percentage of combined YCbCrD coding in each sequence is shown for different QPs. Note that in lower bit rates (higher QP), combined YCbCrD coding is preferred. In Table 10, coding results of view and depth are shown for each sequence with IPPP and IBBP coding structure. To calculate gains for bit rate and distortion, RD calculation method by Bjontegaard Gisle Bjontegaard, “Calculation of Average PSNR Differences between RD curves”, ITU-T SC16/Q6, 13th VCEG Meeting, Austin, Tex., USA, April 2001, Doc. VCEG-M33 was used. Note that we achieved about 6% gains in depth by IPPP and about 5% gains in view by IBBP by our YCbCrD coding scheme.

TABLE 9
Percentage of combined YCbCrD coding (IPPP by Zeus)

| | | QP 22 | QP 27 | QP 32 | QP 37 | Average |
|---|---|---|---|---|---|---|
| Lovebird1 | Percentage of | 60.54% | 69.74% | 78.87% | 87.67% | 74.20% |
| View 2 | combined coding | | | | | |
| Lovebird2 | Percentage of | 42.98% | 51.69% | 60.03% | 68.54% | 55.81% |
| View 7 | combined coding | | | | | |
| Pantomime | Percentage of | 60.29% | 63.96% | 71.06% | 77.58% | 68.22% |
| View 37 | combined coding | | | | | |

TABLE 10
Coding results of view and depth

| | | Coding structure | | | | | |
|---|---|---|---|---|---|---|---|
| | | IPPP | | | IBBP | | |
| | | Lovebird | Lovebird | Pantomime | Lovebird | Lovebird | Pantomime |
| Sequence | | 1 View 2 | 2 View 7 | View 37 | 1 View 2 | 2 View 7 | View 37 |
| PSNR | Bit rate | 1.92% | 3.23% | 0.51% | 4.13% | 6.27% | 4.17% |
| view | PSNR | 0.08 dB | 0.13 dB | 0.02 dB | 0.166 dB | 0.246 dB | 0.162 dB |
| PSNR | Bit rate | 5.10% | 3.92% | 9.32% | 1.38% | 0.88% | 1.31% |
| depth | PSNR | 0.18 dB | 0.17 dB | 0.57 dB | 0.054 dB | 0.041 dB | 0.059 dB |

In Table 11-13, view synthesis results are compared for our YCbCrD coding and separate coding (baseline) for IPPP coding results. The distortions measured by PSNR in each sequence are similar for both YCbCrD and baseline but total bit rates are reduced by YCbCrD coding. However overall coding gains in the synthesized views are less than what have been achieved by the depth coding from Table 8. This is because estimated depths by DERS are not accurate and the qualities of synthesized views depend on the accuracy of VSRS that was not confirmed yet.

TABLE 11
Experimental results of view synthesis for Lovebird1

| Lovebird1 | | QP 22 | QP 27 | QP 32 | QP 37 | Gains |
|---|---|---|---|---|---|---|
| YCbCrD | PSNR (Syn Vew 3) | 43.61 | 40.86 | 37.98 | 35.24 | 0.05 dB |
| | Bit rates (View 2) | 3474 | 1652 | 778 | 388 | |
| | Bit rates (View 4) | 3348 | 1599 | 753 | 379 | |
| | Total bit rates (Kbps) | 6822 | 3251 | 1531 | 767 | 1.22% |
| Baseline | PSNR (Syn Vew 3) | 43.63 | 40.87 | 38.03 | 35.27 | |
| | Bit rates (View 2) | 3515 | 1677 | 797 | 403 | |
| | Bit rates (View 4) | 3394 | 1624 | 767 | 390 | |
| | Total bit rates (Kbps) | 6909 | 3301 | 1564 | 793 | |

TABLE 12
Experimental results of view synthesis for Lovebird2

| Lovebird2 | | QP 22 | QP 27 | QP 32 | QP 37 | Gains |
|---|---|---|---|---|---|---|
| YCbCrD | PSNR (Syn Vew 8) | 42.76 | 40.38 | 37.93 | 35.38 | 0.14 dB |
| | Bit rates (View 7) | 1859 | 954 | 476 | 243 | |
| | Bit rates (View 9) | 1863 | 945 | 465 | 232 | |
| | Total bit rates (Kbps) | 3722 | 1899 | 941 | 475 | 3.78% |
| Baseline | PSNR (Syn Vew 8) | 42.76 | 40.33 | 37.91 | 35.35 | |
| | Bit rates (View 7) | 1883 | 977 | 492 | 257 | |
| | Bit rates (View 9) | 1892 | 966 | 480 | 243 | |
| | Total bit rates (Kbps) | 3775 | 1943 | 972 | 500 | |

TABLE 13
Experimental results of view synthesis for Pantomime

| Pantomime | | QP 22 | QP 27 | QP 32 | QP 37 | Gains |
|---|---|---|---|---|---|---|
| YCbCrD | PSNR (Syn Vew 38) | 46.50 | 44.71 | 42.20 | 39.24 | 0.04 dB |
| | Bit rates (View 37) | 6486 | 3344 | 1836 | 1077 | |
| | Bit rates (View 39) | 6330 | 3274 | 1810 | 1063 | |
| | Total bit rates (Kbps) | 12816 | 6618 | 3646 | 2140 | 0.93% |
| Baseline | PSNR (Syn Vew 38) | 46.48 | 44.70 | 42.19 | 39.24 | |
| | Bit rates (View 37) | 6521 | 3365 | 1848 | 1080 | |
| | Bit rates (View 39) | 6377 | 3300 | 1823 | 1071 | |
| | Total bit rates (Kbps) | 12898 | 6665 | 3671 | 2151 | |

Some or all of the operations set forth in FIGS. 5-6 may be contained as a utility, program, or subprogram, in any desired computer readable storage medium, which may be a non-transitory medium. In addition, the operations may be embodied by computer programs, which can exist in a variety of forms both active and inactive. For example, they may exist as software program(s) comprised of program instructions in source code, object code, executable code or other formats. Any of the above may be embodied on a computer readable storage medium, which include storage devices.

Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the embodiments of the invention.

The invention allows 3D encoding of a depth parameter jointly with view information. The invention allows for compatibility with 2D and may provide optimized encoding based on the RD costs in encoding depth jointly with view or separately. Also, from the new definition of video format, we provide an adaptive coding method of 3D video signal. During the combined coding of RGBD, YUVD, and YCbCrD in the adaptive coding of 3D signal, we treat depth as a video component from the beginning thus, in inter prediction, block mode and reference index are shared between view and depth in addition to motion vector. In intra prediction, intra prediction mode can be shared also. Note that the coding result of combined coding can be further optimized by considering depth information together with view. In the separate coding of view and depth, depth is coded independently to the view. It is also possible to have intra coded depth while view is inter coded.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What is claimed is:

1. An apparatus for encoding video data comprising:
an encoder configured to encode said video data by encoding a combined set of view data and depth data.

2. The apparatus of claim 1, wherein said combined set of view data and depth data includes one of: RGBD, YUVD, or YCbCrD.

3. The apparatus of claim 2, wherein said combined set of view data and depth data is contained in at least one of: a group of pictures, a picture, a slice, a group of blocks, a macroblock, or a sub-macroblock.

4. The apparatus of claim 1, further comprising a depth format unit configured to identify a depth format of said video data.

5. The apparatus of claim 4, wherein said encoder selects to encode said video data as a plurality of two dimensional images without including depth data when said depth format is set to 0.

6. The apparatus of claim 4, wherein said encoder selects to encode said video data as said combined set of view data and depth data when said depth format is set to a predetermined level.

7. The apparatus of claim 1, wherein said encoder further includes a coding cost calculator which determines coding costs of joint encoding of said combined set of view data and depth data and separate encoding of said combined set of view data and depth data, and determines an encoding mode between joint encoding and separate encoding based on said coding costs.

8. The apparatus of claim 7, wherein said encoder encodes said video data as a joint encoding of view data and depth data when said encoding cost is less than an encoding cost of separately encoding said view data and depth data.

9. The apparatus of claim 1, wherein said video data is one of a: multiview with depth, multiview without depth, single view with depth, single view without depth.

10. A method of encoding video data comprising:
encoding said video data by encoding a combined set of view data and depth data at an encoder.

11. The method of claim 10, wherein said combined set of view data and depth data includes one of: RGBD, YUVD, or YCbCrD.

12. The method of claim 11, wherein said combined set of view data and depth data is contained in at least one of: a group of pictures, a picture, a slice, a group of blocks, a macroblock, or a sub-macroblock.

13. The method of claim 10, further comprising identifying a depth format of said video data.

14. The method of claim 13, wherein said video data is encoded as a plurality of two dimensional images without including depth data when said depth format is set to 0.

15. The method of claim 13, wherein said combined set of view data and depth data is encoded when said depth format is set to a predetermined level.

16. The method of claim 10, further including determining a coding cost of joint encoding said combined set of view data and depth data and separate encoding of said combined set of view data and depth data, and determining an encoding mode between joint encoding and separate encoding based on said coding costs.

17. The method of claim 16, wherein said video data is encoded as a joint encoding of view data and depth data when said encoding cost is less than an encoding cost of separately encoding said view data and depth data.

18. The method of claim 10, wherein said video data is one of a: multiview with depth, multiview without depth, single view with depth, single view without depth.

19. A non-transitory computer readable medium carrying instructions for an encoder to encode video data, comprising instruction to perform said steps of:
encoding said video data by encoding a combined set of view data and depth data.

20. The computer readable medium of claim 19, wherein said combined set of view data and depth data includes one of: RGBD, YUVD, or YCbCrD.

21. The computer readable medium of claim 20, wherein said combined set of view data and depth data is contained in at least one of: a group of pictures, a picture, a slice, a group of blocks, a macroblock, or a sub-macroblock.

22. The computer readable medium of claim 19, further comprising identifying a depth format of said video data.

23. The computer readable medium of claim 22, wherein said video data is encoded as a plurality of two dimensional images without including depth data when said depth format is set to 0.

24. The computer readable medium of claim 22, wherein said combined set of view data and depth data is encoded jointly when said depth format is set to a predetermined level.

25. The computer readable medium of claim 19, further including determining a coding cost of joint encoding said combined set of view data and depth data and separate encoding of said combined set of view data and depth data, and determining an encoding mode between joint encoding and separate encoding based on said coding cost.

26. The computer readable medium of claim 25, wherein said video data is encoded as a joint encoding of view data and depth data when said encoding cost is less than an encoding cost of separately encoding said view data and depth data.

27. The computer readable medium of claim 19, wherein said video data is one of a: multiview with depth, multiview without depth, single view with depth, single view without depth.

28. An apparatus for decoding video data comprising:
a decoder configured to decode said video data by decoding a combined set of view data and depth data.

29. The apparatus of claim 28, wherein said combined set of view data and depth data includes one of: RGBD, YUVD, or YCbCrD.

30. The apparatus of claim 29, wherein said combined set of view data and depth data is contained in at least one of: a group of pictures, a picture, a slice, a group of blocks, a macroblock, or a sub-macroblock.

31. The apparatus of claim 28, further comprising a depth format unit configured to identify a depth format of said video data.

32. The apparatus of claim 31, wherein said decoder selects to decode said video data as a plurality of two dimensional images without including depth data when said depth format is set to 0.

33. The apparatus of claim 31, wherein said decoder selects to decode said video data as said combined set of view data and depth data when said depth format is set to a predetermined level.

34. The apparatus of claim 28, wherein said decoder selectively jointly decodes said combined set of view data and depth data when said combined set was jointly encoded or decodes said combined set of view data and depth data when said combined set was separately encoded.

35. The apparatus of claim 28, wherein said video data is one of a: multiview with depth, multiview without depth, single view with depth, single view without depth.

36. A method of decoding video data comprising:
decoding said video data by decoding a combined set of view data and depth data at a decoder.

37. The method of claim 36, wherein said combined set of view data and depth data includes one of: RGBD, YUVD, or YCbCrD.

38. The method of claim 37, wherein said combined set of view data and depth data is contained in at least one of: a group of pictures, a picture, a slice, a group of blocks, a macroblock, or a sub-macroblock.

39. The method of claim 36, further comprising identifying a depth format of said video data.

40. The method of claim 39, wherein said video data is decoded as a plurality of two dimensional images without including depth data when said depth format is set to 0.

41. The method of claim 39, wherein said combined set of view data and depth data is decoded jointly when said depth format is set to a predetermined level.

42. The method of claim 36, further including selectively jointly decoding said combined set of view data and depth data when said combined set was jointly encoded or decoding said combined set of view data and depth data when said combined set was separately encoded.

43. The method of claim 36, wherein said video data is one of a: multiview with depth, multiview without depth, single view with depth, single view without depth.

44. A non-transitory computer readable medium carrying instructions for a decoder to decode video data, comprising instruction to perform said steps of:
decoding said video data by encoding a combined set of view data and depth data.

45. The computer readable medium of claim 44, wherein said combined set of view data and depth data includes one of: RGBD, YUVD, or YCbCrD.

46. The computer readable medium of claim 45, wherein said combined set of view data and depth data is contained in at least one of: a group of pictures, a picture, a slice, a group of blocks, a macroblock, or a sub-macroblock.

47. The computer readable medium of claim 44, further comprising identifying a depth format of said video data.

48. The computer readable medium of claim 47, wherein said video data is decoded as a plurality of two dimensional images without including depth data when said depth format is set to 0.

49. The computer readable medium of claim 47, wherein said combined set of view data and depth data is decoded jointly when said depth format is set to a predetermined level.

50. The computer readable medium of claim 44, further including selectively jointly decoding said combined set of view data and depth data when said combined set was jointly encoded or decoding said combined set of view data and depth data when said combined set was separately encoded.

51. The computer readable medium of claim 44, wherein said video data is one of a: multiview with depth, multiview without depth, single view with depth, single view without depth.
